(19) United States
(12) Patent Application Publication
(10) Pub. No.: US 2026/0268828 A1
(43) Pub. Date: Sep. 10, 2026

(54) DISPLAY CONTROL CIRCUIT INCLUDING AMPLIFIER CIRCUIT, DISPLAY DEVICE INCLUDING THE SAME AND METHOD OF CONTROLLING THE AMPLIFIER CIRCUIT

(71) Applicant: SAMSUNG ELECTRONICS CO., LTD., Suwon-si (KR)

(72) Inventors: Ji-Yong JEONG, Suwon-si (KR); Hyunsik LEE, Suwon-si (KR); Donghan LEE, Suwon-si (KR)

(73) Assignee: SAMSUNG ELECTRONICS CO., LTD., Suwon-si (KR)

(21) Appl. No.: 19/552,229

(22) Filed: Feb. 27, 2026

(30) Foreign Application Priority Data
Mar. 6, 2025 (KR) 10-2025-0029056
Jul. 17, 2025 (KR) 10-2025-0097006

(51) Int. Cl. G09G 3/20

(52) U.S. Cl. CPC G09G 3/2092; G09G 2310/0291

(57) ABSTRACT

A display control circuit including an amplifier circuit connected to first pixels through a first pixel switch and to second pixels through a second pixel switch and a controller electrically connected to the amplifier circuit. The amplifier circuit may include a first sub-circuit and a second sub-circuit connected through at least one internal switch, and the controller may be configured to turn off the at least one internal switch in response to the first pixel switch and the second pixel switch being turned off, such that the amplifier circuit outputs a first output voltage based on an input signal through the first sub-circuit.

### CROSS-REFERENCE TO RELATED APPLICATIONS

This U.S. non-provisional application claims priority under 35 USC § 119 to Korean Patent Application Nos. 10-2025-0029056, filed on Mar. 6, 2025, and 10-2025-0097006, filed on Jul. 17, 2025 in the Korean Intellectual Property Office, the disclosure of which are herein incorporated by reference in their entirety.

### BACKGROUND

Embodiments of the present disclosure relate to a display control circuit including an amplifier circuit, a display device including the same, and a method of controlling the amplifier circuit.

A display device includes a display panel for displaying an image and a display driving circuit for driving the display panel. The display driving circuit may receive image data from an external source and apply an image signal corresponding to the received image data to a data line of the display panel to drive the display panel.

The display driving circuit may include an amplifier circuit configured to amplify the image signal and apply the amplified image signal to a connected data line of the display panel. Recently, a technique has been utilized where a single amplifier circuit, connected to a plurality of data lines, sequentially applies image signals to the plurality of data lines.

### SUMMARY

Embodiments of the present disclosure provide a display device that improves the quality of an image output through a display panel.

According to one or more embodiments, a display control circuit includes an amplifier circuit connected to a plurality of first pixels through a first pixel switch and to a plurality of second pixels through a second pixel switch and a controller electrically connected to the amplifier circuit. The amplifier circuit may include a first sub-circuit and a second sub-circuit connected through at least one internal switch, and the controller may be configured to turn off the at least one internal switch in response to the first pixel switch and the second pixel switch being turned off, such that the amplifier circuit outputs a first output voltage based on an input signal through the first sub-circuit.

According to one or more embodiments, a display device includes an amplifier circuit including a first sub-circuit and a second sub-circuit connected through at least one internal switch, a plurality of first pixels connected to the amplifier circuit through a first pixel switch, a plurality of second pixels connected to the amplifier circuit through a second pixel switch, and a controller electrically connected to the amplifier circuit. The controller may be configured to turn off the at least one internal switch in response to the first pixel switch and the second pixel switch being turned off, and turn on the at least one internal switch in response to the first pixel switch being turned on.

According to one or more embodiments, a method of controlling an amplifier circuit connected to first pixels through a first pixel switch and to second pixels through a second pixel switch includes turning off at least one internal switch connected between a first sub-circuit and a second sub-circuit in response to the first pixel switch and the second pixel switch being turned off, such that the amplifier circuit outputs a first output voltage based on an input signal through the first sub-circuit, and turning on the at least one internal switch in response to the first pixel switch being turned on, such that the amplifier circuit outputs a second output voltage based on the input signal through the first sub-circuit and the second sub-circuit.

### BRIEF DESCRIPTION OF DRAWINGS

FIG. 1 is a diagram illustrating a display device according to one or more embodiments.

FIG. 2 is a diagram illustrating a first clock signal, a second clock signal, and a control signal according to one or more embodiments.

FIG. 3 is a block diagram of an amplifier circuit according to one or more embodiments.

FIG. 4 is a diagram illustrating a display device according to one or more embodiments.

FIG. 5 is a circuit diagram of an amplifier circuit according to one or more embodiments.

FIG. 6A is a circuit diagram of an amplifier circuit when a first pixel switch and a second pixel switch are turned off, according to one or more embodiments.

FIG. 6B is a circuit diagram of an amplifier circuit further including a first internal buffer and a second internal buffer, according to one or more embodiments.

FIG. 7 is a circuit diagram of an amplifier circuit when a first pixel switch is turned on, according to one or more embodiments.

FIG. 8 is a flowchart illustrating a method of controlling an amplifier circuit according to one or more embodiments.

FIG. 9 is a block diagram of an Internet of Things (IoT) device including a display device according to one or more embodiments.

FIG. 10 is a block diagram of a mobile terminal to which a display device according to one or more embodiments is applied.

### DETAILED DESCRIPTION

The following description with reference to the accompanying drawings is provided to assist in a comprehensive understanding of various embodiments of the present disclosure.

The term "first," "second," or the like used herein may modify various elements regardless of the order and/or priority thereof, and is used only for distinguishing one element from another element, without limiting example embodiments.

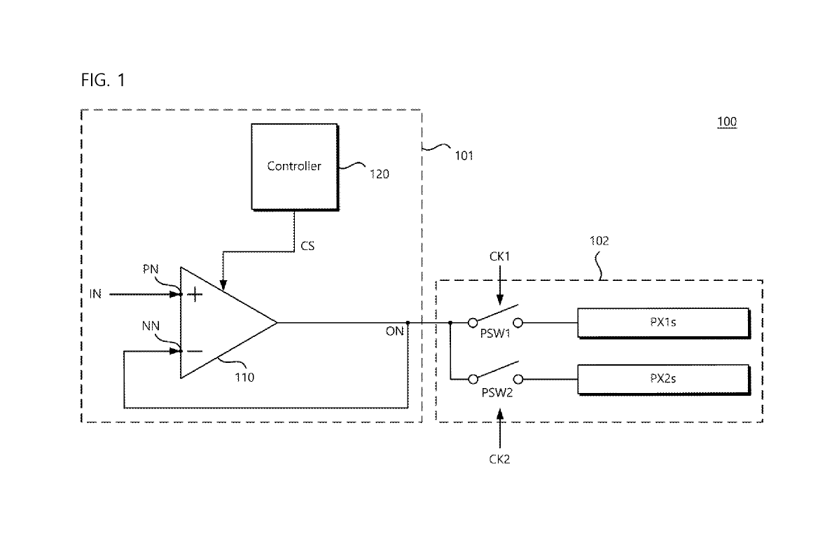

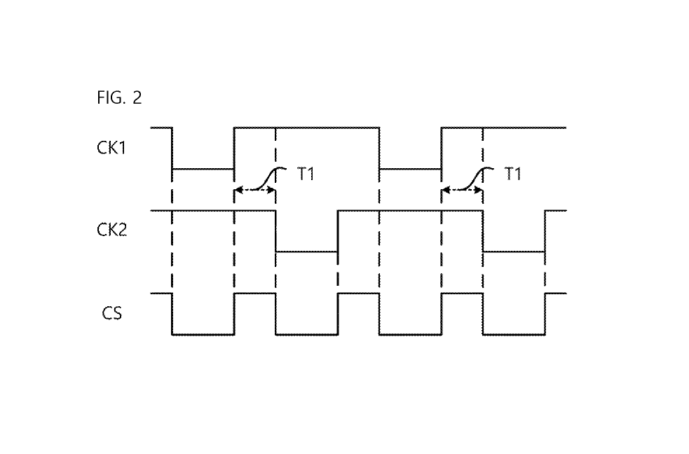

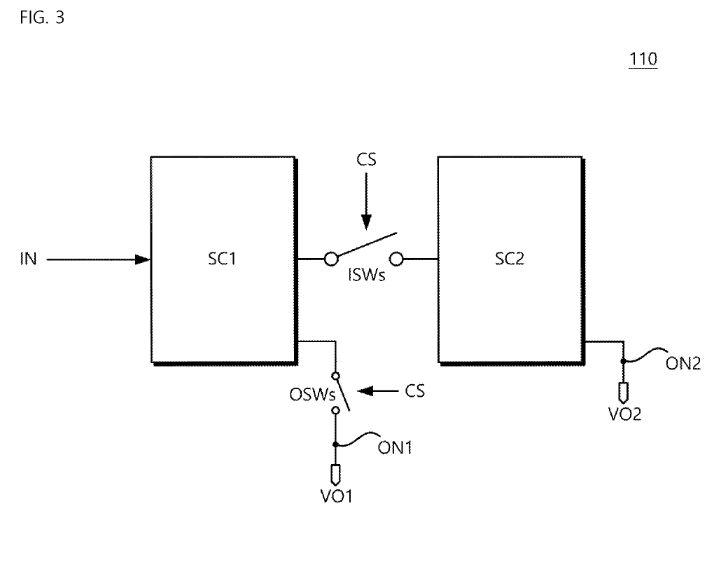

FIG. 1 is a diagram illustrating a display device according to one or more embodiments. FIG. 2 is a diagram illustrating a first clock signal, a second clock signal, and a control signal according to one or more embodiments. FIG. 3 is a block diagram of an amplifier circuit according to one or more embodiments.

Referring to FIG. 1, a display device 100 according to one or more embodiments may include a display control circuit 101 and a display panel 102.

The display panel 102 may include a plurality of first pixels PX1s and a plurality of second pixels PX2s. The plurality of first pixels PX1s may form a single column of pixels arranged in a matrix in the display panel 102. The plurality of second pixels PX2s may form a single column of pixels arranged in a matrix in the display panel 102.

The display panel 102 may include a first pixel switch PSW1 connected between the display control circuit 101 and the plurality of first pixels PX1s. In addition, the display panel 102 may include a second pixel switch PSW2 connected between the display control circuit 101 and the plurality of second pixels PX2s.

The first pixel switch PSW1 may operate based on a first clock signal CK1, and the second pixel switch PSW2 may operate based on a second clock signal CK2.

For example, referring to FIGS. 1 and 2, the first pixel switch PSW1 may be turned on in response to a first clock signal CK1 having a logic low level. The first pixel switch PSW1 may be turned off in response to a first clock signal CK1 having a logic high level. In addition, for example, the second pixel switch PSW2 may be turned on in response to a second clock signal CK2 having a logic low level. The second pixel switch PSW2 may be turned off in response to a second clock signal CK2 having a logic high level.

Referring to FIG. 2, the first pixel switch PSW1 and the second pixel switch PSW2 according to one or more embodiments may be alternately turned on.

For example, the first pixel switch PSW1 may be turned on while the second pixel switch PSW2 is turned off. The second pixel switch PSW2 may be turned on after a first time interval T1 from a time point at which the first pixel switch PSW1 is turned off.

For example, the first pixel switch PSW1 and the second pixel switch PSW2 may be alternately turned on with a certain time interval.

In addition, the display control circuit 101 may include an amplifier circuit 110 and a controller 120.

For example, the display control circuit 101 may include an amplifier circuit 110 that amplifies an input signal IN and transmits the amplified signal to the plurality of first pixels PX1s or the plurality of second pixels PX2s.

The amplifier circuit 110 may receive the input signal IN through a positive input terminal PN. An output node ON of the amplifier circuit 110 may be connected to a negative input terminal NN of the amplifier circuit 110. Accordingly, the amplifier circuit 110 may be understood as a negative feedback amplifier that receives at least a portion of an output signal as an input.

According to one or more embodiments, the amplifier circuit 110 may be connected to the plurality of first pixels PX1s and the plurality of second pixels PX2s.

For example, the amplifier circuit 110 may be connected to the plurality of first pixels PX1s through the first pixel switch PSW1. In addition, the amplifier circuit 110 may be connected to the plurality of second pixels PX2s through the second pixel switch PSW2.

The display control circuit 101 may include a controller 120, electrically connected to the amplifier circuit 110.

The controller 120 may, for example, execute software (or a program) to control at least one other component (for example, the amplifier circuit 110) of the display control circuit 101 (or the display device 100) and may perform various data processing or operations. The controller 120 may include a central processing unit (CPU) or a microprocessor and may control the overall operation of the display control circuit 101. Accordingly, an operation performed by the display control circuit 101 described below may be understood as being performed under the control of the controller 120.

According to one or more embodiments, the controller 120 may include an algorithm for controlling the amplifier circuit 110. For example, the algorithm may be a software code programmed inside the controller 120. For example, the algorithm may be a hard code hard-coded inside the controller 120, but embodiments are not limited thereto.

The controller 120 may control a voltage output to the display panel 102 through the amplifier circuit 110 based on the input signal IN according to the algorithm.

Referring to FIG. 3, the amplifier circuit 110 according to one or more embodiments may include a first sub-circuit SC1 and a second sub-circuit SC2 connected through at least one internal switch ISWs.

The amplifier circuit 110 may further include at least one output switch OSWs connected to a first output node ON1. Referring to FIG. 3, the at least one output switch OSWs is illustrated as being connected between the first sub-circuit SC1 and the first output node ON1, but the configuration of the at least one output switch OSWs is not limited thereto. For example, the first output node ON1 and the at least one output switch OSWs may be formed inside the first sub-circuit SC1.

Each of the first sub-circuit SC1 and the second sub-circuit SC2 may be referred to as a circuit amplifying and outputting a received signal. Accordingly, the amplifier circuit 110 according to one or more embodiments may be understood as a multi-stage amplifier in which a plurality of circuits that amplify and output a received signal are cascaded.

Referring to FIGS. 1-3, the controller 120 may control the amplifier circuit 110 based on an operating state of each of the first pixel switch PSW1 and the second pixel switch PSW2. For example, the controller 120 may control the amplifier circuit 110 based on whether the amplifier circuit 110 is electrically connected to the plurality of first pixels PX1s or the plurality of second pixels PX2s.

According to one or more embodiments, the controller 120 may turn off the at least one internal switch ISWs in response to the first pixel switch PSW1 and the second pixel switch PSW2 being turned off.

For example, the controller 120 may output a control signal CS having a logic high level to the amplifier circuit 110 in response to the first pixel switch PSW1 and the second pixel switch PSW2 being turned off. The at least one internal switch ISWs may be turned off in response to the control signal CS having a logic high level.

The controller 120 may turn on the at least one output switch OSWs in response to the first pixel switch PSW1 and the second pixel switch PSW2 being turned off. The at least one output switch OSWs may be turned on in response to the control signal CS having a logic high level.

The amplifier circuit 110 may output a first output voltage VO1 based on an input signal IN through the first sub-circuit SC1. For example, the amplifier circuit 110 may amplify the input signal IN through the first sub-circuit SC1 and output it as the first output voltage VO1.

For example, the amplifier circuit 110 may operate as a single stage amplifier when the first pixel switch PSW1 and the second pixel switch PSW2 are turned off. For example, the amplifier circuit 110 may operate as a single stage amplifier during a first time interval T1 when the first pixel switch PSW1 and the second pixel switch PSW2 are turned off.

According to one or more embodiments, the controller 120 may turn on the at least one internal switch ISWs in response to one of the first pixel switch PSW1 and the second pixel switch PSW2 being turned on.

For example, the controller 120 may output a control signal CS having a logic low level in response to the first pixel switch PSW1 being turned on. The at least one internal switch ISWs may be turned on in response to the control signal CS having a logic low level.

In addition, the controller 120 may turn off the at least one output switch OSWs in response to the first pixel switch PSW1 being turned on. The at least one output switch OSWs may be turned off in response to the control signal CS having a logic low level.

The amplifier circuit 110 may output a second output voltage VO2 based on the input signal IN through the first sub-circuit SC1 and the second sub-circuit SC2. For example, the amplifier circuit 110 may amplify the input signal IN using the first sub-circuit SC1 and the second sub-circuit SC2 and output the amplified input signal IN as the second output voltage VO2 through a second output node ON2. In FIG. 3, the second output node ON2 is illustrated as being connected to the second output node ON2 from the outside of the second sub-circuit SC2, but embodiments are not limited thereto. For example, the second output node ON2 may be formed inside the second sub-circuit SC2.

For example, the amplifier circuit 110 may operate as a multi-stage amplifier while one of the first pixel switch PSW1 and the second pixel switch PSW2 is turned on.

Referring to the above-described components, a controller 120 according to one or more embodiments may control the amplifier circuit 110 based on whether the amplifier circuit 110 is electrically connected to the plurality of first pixels PX1s or the plurality of second pixels PX2s.

For example, when the amplifier circuit 110 is electrically open to the plurality of first pixels PX1s and the plurality of second pixels PX2s, the controller 120 may control the amplifier circuit 110 to operate as a single stage amplifier.

As a result, the controller 120 may increase a phase margin and/or a gain margin of the amplifier circuit 110 while the amplifier circuit 110 is electrically open to the plurality of first pixels PX1s and the plurality of second pixels PX2s.

Accordingly, the controller 120 may reduce oscillation (or ringing) occurring at an output of the amplifier circuit 110.

Through the above-described components, the display device 100 according to one or more embodiments may improve the quality of an image output through the display panel 102.

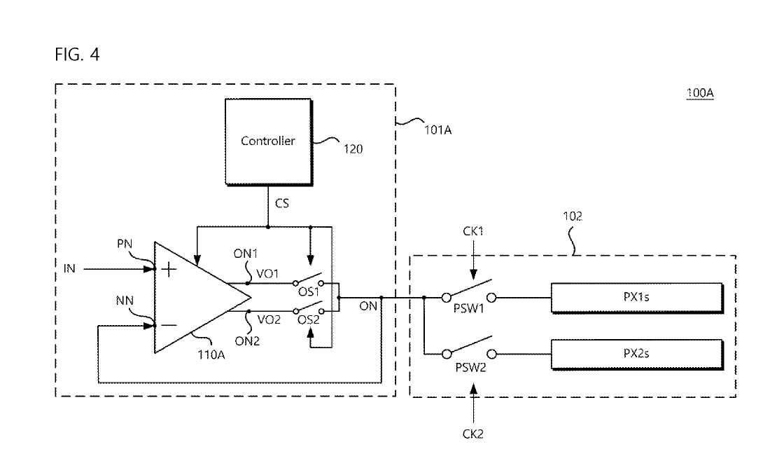

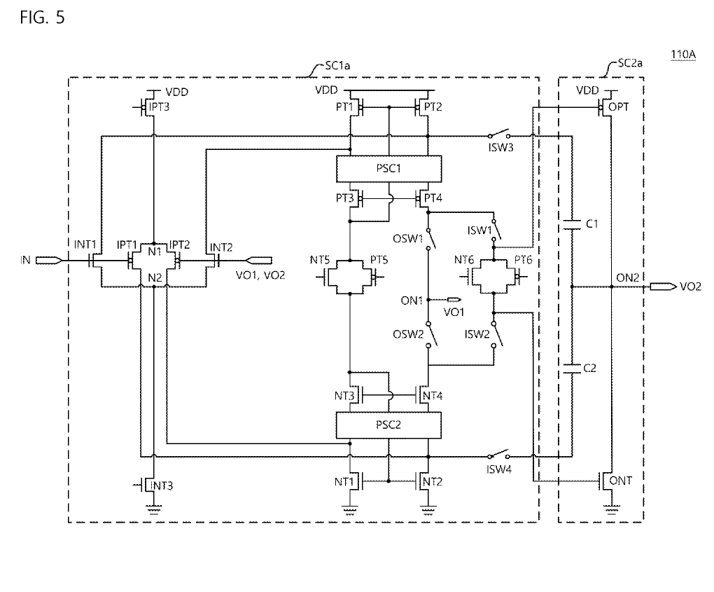

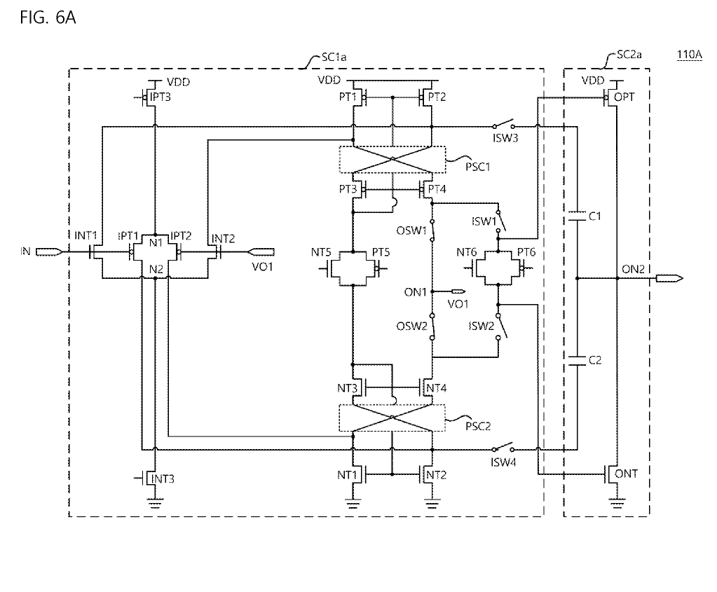

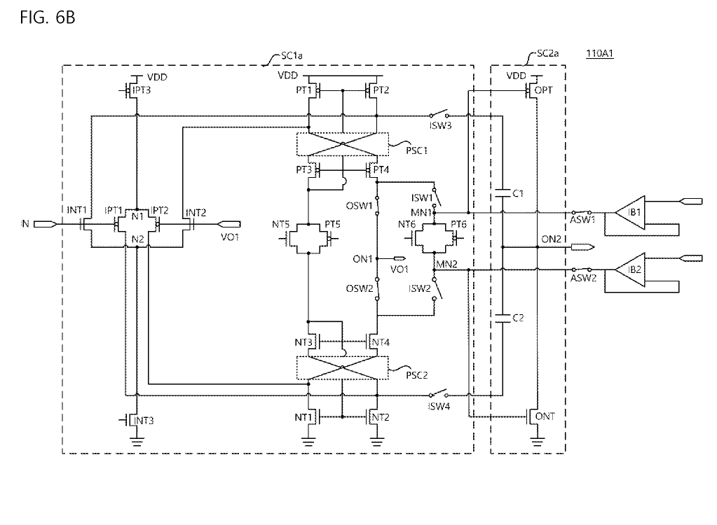

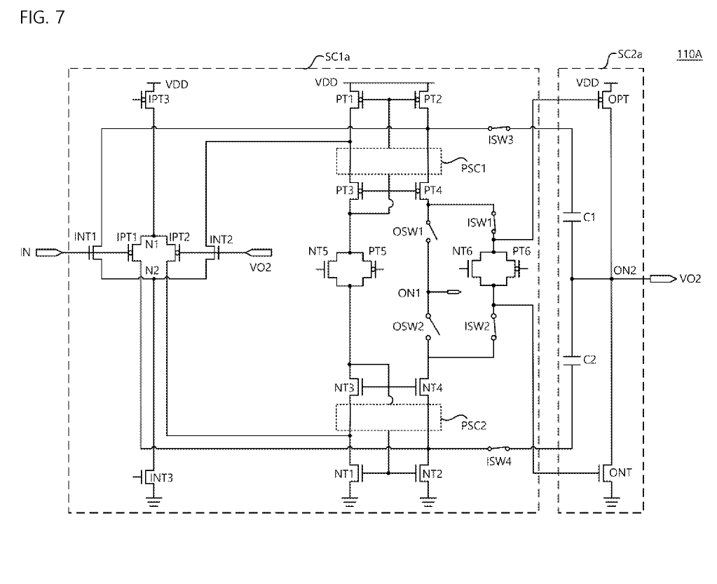

FIG. 4 is a diagram illustrating a display device according to one or more embodiments. FIG. 5 is a circuit diagram of an amplifier circuit according to one or more embodiments. FIG. 6A is a circuit diagram of an amplifier circuit when a first pixel switch and a second pixel switch are turned off, according to one or more embodiments. FIG. 6B is a circuit diagram of an amplifier circuit further including a first internal buffer and a second internal buffer, according to one or more embodiments. FIG. 7 is a circuit diagram of an amplifier circuit when a first pixel switch is turned on, according to one or more embodiments.

Referring to FIG. 4, a display device 100A according to one or more embodiments may include a display control circuit 101A and a display panel 102.

The display device 100A illustrated in FIG. 4 may be understood as an example of the display device 100 illustrated in FIG. 1. Accordingly, the same or substantially the same components as those described above are denoted by the same reference numerals, and redundant descriptions thereof will be omitted to avoid redundancy.

The display control circuit 101A may include an amplifier circuit 110A, a controller 120, a first external switch OS1, and a second external switch OS2.

For example, the display control circuit 101A may include an amplifier circuit 110A amplifying an input signal IN and transmitting an amplified version of the input signal IN to the plurality of first pixels PX1s or the plurality of second pixels PX2s.

Referring to FIG. 5, the amplifier circuit 110A according to one or more embodiments may include a first sub-circuit SC1a and a second sub-circuit SC2a.

For example, the amplifier circuit 110A may include a first sub-circuit SC1a and a second sub-circuit SC2a which are connected to each other through a plurality of internal switches ISW1 to ISW4.

Each of the first sub-circuit SC1a and the second sub-circuit SC2a may include a plurality of transistors and a plurality of switches.

The first sub-circuit SC1a may include a first PMOS transistor PT1 and a second PMOS transistor PT2, each connected to a power supply voltage VDD. A gate electrode of the first PMOS transistor PT1 may be connected to a gate electrode of the second PMOS transistor PT2.

The first sub-circuit SC1a may include a first polarity switch circuit PSC1 connected to the first PMOS transistor PT1 and the second PMOS transistor PT2.

In addition, the first sub-circuit SC1a may include a third PMOS transistor PT3 and a fourth PMOS transistor PT4, each connected to the first polarity switch circuit PSC1. A gate electrode of the third PMOS transistor PT3 may be connected to a gate electrode of the fourth PMOS transistor PT4. A drain electrode of the third PMOS transistor PT3 may be connected to the gate electrodes of the first PMOS transistor PT1 and the second PMOS transistor PT2.

In addition, the first sub-circuit SC1a may include a first NMOS transistor NT1 and a second NMOS transistor NT2, each connected to a ground. A gate electrode of the first NMOS transistor NT1 may be connected to a gate electrode of the second NMOS transistor NT2.

In addition, the first sub-circuit SC1a may include a second polarity switch circuit PSC2 connected to the first NMOS transistor NT1 and the second NMOS transistor NT2.

In addition, the first sub-circuit SC1a may include a third NMOS transistor NT3 and a fourth NMOS transistor NT4, each connected to the second polarity switch circuit PSC2. A gate electrode of the third NMOS transistor NT3 may be connected to a gate electrode of the fourth NMOS transistor NT4. A drain electrode of the third NMOS transistor NT3 may be connected to the gate electrodes of the first NMOS transistor NT1 and the second NMOS transistor NT2.

In addition, the first sub-circuit SC1a may include a first output switch OSW1 connected between a drain electrode of the fourth PMOS transistor PT4 and a first output node ON1. The first sub-circuit SC1a may include a second output switch OSW2 connected between a drain electrode of the fourth NMOS transistor NT4 and a first output node ON1.

The first sub-circuit SC1a may include a first internal switch ISW1 connected in parallel to the first output switch OSW1 to the fourth PMOS transistor PT4. In addition, the first sub-circuit SC1a may include a second internal switch ISW2 connected in parallel to the second output switch OSW2 to the fourth NMOS transistor NT4.

The first sub-circuit SC1a may include a fifth PMOS transistor PT5 and a fifth NMOS transistor NT5 connected in parallel between the third PMOS transistor PT3 and the third NMOS transistor NT3. The first sub-circuit SC1a may include a sixth PMOS transistor PT6 and a sixth NMOS transistor NT6 connected in parallel between the first internal switch ISW1 and the second internal switch ISW2.

The first sub-circuit SC1a may include a first input NMOS transistor INT1 and a first input PMOS transistor IPT1, which receive the input signal IN through respective gate electrodes. In addition, the first sub-circuit SC1a may include a second input NMOS transistor INT2 and a second input PMOS transistor IPT2, which receive outputs VO1 and VO2 of the amplifier circuit 110A through respective gate electrodes.

The first sub-circuit SC1a may include a third input PMOS transistor IPT3 connected between a first node N1, between the first input PMOS transistor IPT1 and the second input PMOS transistor IPT2, and the power supply voltage VDD. In addition, the first sub-circuit SC1a may include a third input NMOS transistor INT3 connected between a second node N2, between the first input NMOS transistor INT1 and the second input NMOS transistor INT2, and ground.

A source electrode of the first input NMOS transistor INT1 may be connected to a drain electrode of the second PMOS transistor PT2. A source electrode of the second input NMOS transistor INT2 may be connected to a drain electrode of the first PMOS transistor PT1. A drain electrode of the first input PMOS transistor IPT1 may be connected to a source electrode of the first NMOS transistor NT1. A drain electrode of the second input PMOS transistor IPT2 may be connected to a source electrode of the second NMOS transistor NT2.

Referring to FIG. 5, the second sub-circuit SC2a may include a plurality of output transistors OPT and ONT and a plurality of capacitors C1 and C2.

For example, the second sub-circuit SC2a may include an output PMOS transistor OPT connected between the power supply voltage VDD and a second output node ON2. In addition, the second sub-circuit SC2a may include an output NMOS transistor ONT connected between the second output node ON2 and ground.

The second sub-circuit SC2a may include a first capacitor C1 connected between a third internal switch ISW3 and the second output node ON2. The third internal switch ISW3 may be connected to the second PMOS transistor PT2 and the first input NMOS transistor INT1.

The second sub-circuit SC2a may include a second capacitor C2 connected between a fourth internal switch ISW4 and the second output node ON2. The fourth internal switch ISW4 may be connected to the second NMOS transistor NT2 and the first input PMOS transistor IPT1.

Returning to FIG. 4, the display control circuit 101A may include a first external switch OS1 and a second external switch OS2.

For example, the display control circuit 101A may include a first external switch OS1 connected to a first output node ON1 of the amplifier circuit 110A. In addition, the display control circuit 101A may include a second external switch OS2 connected to a second output node ON2 of the amplifier circuit 110A.

Referring to FIGS. 4-7, the controller 120 according to one or more embodiments may control at least a portion of a plurality of switches included in the amplifier circuit 110A based on an operating state of the first pixel switch PSW1 and the second pixel switch PSW2.

In addition, the controller 120 may control at least a portion of the first external switch OS1 and the second external switch OS2 based on an operating state of the first pixel switch PSW1 and the second pixel switch PSW2.

Referring to FIGS. 4 and 6A, a controller 120 according to one or more embodiments may turn off the internal switches ISW1 to ISW4 in response to the first pixel switch PSW1 and the second pixel switch PSW2 being turned off.

For example, the controller 120 may apply a control signal CS having a logic high level to each of the first internal switch ISW1 to the fourth internal switch ISW4 in response to the first pixel switch PSW1 and the second pixel switch PSW2 being turned off. The first internal switch ISW1 to the fourth internal switch ISW4 may be turned off in response to the control signal CS having a logic high level.

For example, the controller 120 may electrically open the first sub-circuit SC1a and the second sub-circuit SC2a in response to the first pixel switch PSW1 and the second pixel switch PSW2 being turned off.

In addition, the controller 120 may turn on the output switches OSW1 and OSW2 in response to the first pixel switch PSW1 and the second pixel switch PSW2 being turned off.

For example, the controller 120 may apply a control signal CS having a logic high level to each of the output switches OSW1 and OSW2 in response to the first pixel switch PSW1 and the second pixel switch PSW2 being turned off. The output switches OSW1 and OSW2 may be turned on in response to the control signal CS having a logic high level.

The amplifier circuit 110A may output a first output voltage VO1 based on an input signal IN through a first output node ON1 of the first sub-circuit SC1a. For example, the amplifier circuit 110A may amplify the input signal IN through the first sub-circuit SC1a and output the amplified signal as the first output voltage VO1 through the first output node ON1.

For example, the amplifier circuit 110A may operate as a single stage amplifier while the first pixel switch PSW1 and the second pixel switch PSW2 are turned off.

In addition, when the amplifier circuit 110A outputs the first output voltage VO1 through the first output node ON1, the controller 120 may turn on the first external switch OS1.

For example, the controller 120 may output a control signal CS having a logic high level in response to the first pixel switch PSW1 and the second pixel switch PSW2 being turned off. The first external switch OS1 may be turned on in response to the control signal CS having a logic high level.

In addition, the controller 120 may turn off the second external switch OS2 in response to the first pixel switch PSW1 and the second pixel switch PSW2 being turned off. For example, the second external switch OS2 may be turned off in response to the control signal CS having a logic high level.

Accordingly, the controller 120 may control at least a portion of the first external switch OS1 and the second external switch OS2 to transmit the first output voltage VO1 to the output node ON while the amplifier circuit 110A operates as a single stage amplifier.

Referring to FIG. 6B, an amplifier circuit 110A1 according to one or more embodiments may further include a first internal buffer IB1 and a second internal buffer IB2. The amplifier circuit 110A1 illustrated in FIG. 6B may be understood as a configuration that further includes the first internal buffer IB1 and the second internal buffer IB2 in the amplifier circuit 110A illustrated in FIG. 6A.

For example, the amplifier circuit 110A1 may further include a first internal buffer IB1 connected to a first intermediate node MN1 between the sixth NMOS transistor NT6 and the sixth PMOS transistor PT6, and the first internal switch ISW1. The first internal buffer IB1 may be connected to the first intermediate node MN1 through a first additional switch ASW1.

For example, the amplifier circuit 110A1 may further include a second internal buffer IB2 connected to a second intermediate node MN2 between the sixth NMOS transistor NT6 and the sixth PMOS transistor PT6 and the second internal switch ISW2. The second internal buffer IB2 may be connected to the second intermediate node MN2 through a second additional switch ASW2.

The controller 120 according to one or more embodiments may turn on the first additional switch ASW1 and the second additional switch ASW2 in response to the first internal switch ISW1 and the second internal switch ISW2 being turned off.

For example, the controller 120 may electrically connect the first internal buffer IB1 to the first intermediate node MN1 in response to the first internal switch ISW1 and the second internal switch ISW2 being turned off. In addition, the controller 120 may electrically connect the second internal buffer IB2 to the second intermediate node MN2 in response to the first internal switch ISW1 and the second internal switch ISW2 being turned off.

The first internal buffer IB1 and the second internal buffer IB2 may maintain voltages at the first intermediate node MN1 and the second intermediate node MN2 within a certain range.

For example, when the first internal buffer IB1 is connected to the first intermediate node MN1 through the first additional switch ASW1, the first internal buffer IB1 may maintain the voltage at the first intermediate node MN1 within a certain range from a predetermined value. For example, the first internal buffer IB1 may maintain the voltage at the first intermediate node MN1 at a predetermined value.

In addition, when the second internal buffer IB2 is connected to the second intermediate node MN2 through the second additional switch ASW2, the second internal buffer IB2 may maintain the voltage at the second intermediate node MN2 within a certain range from a predetermined value. For example, the second internal buffer IB2 may maintain the voltage at the second intermediate node MN2 at a predetermined value.

For example, the amplifier circuit 110A1 (or, the controller 120) according to one or more embodiments may maintain a voltage across the sixth NMOS transistor NT6 and the sixth PMOS transistor PT6 within a certain range from a predetermined value by using the first internal buffer IB1 and the second internal buffer IB2 when the first internal switch ISW1 and the second internal switch ISW2 are turned off.

As a result, the amplifier circuit 110A1 according to one or more embodiments may maintain the magnitude of a voltage applied to the gate electrode of each of the output PMOS transistor OPT and the output NMOS transistor ONT within a certain range.

Referring to FIGS. 4 and 7, a controller 120 according to one or more embodiments may turn on the internal switches ISW1 to ISW4 in response to one of the first pixel switch PSW1 and the second pixel switch PSW2 being turned on.

For example, the controller 120 may apply a control signal CS having a logic low level to each of the first internal switch ISW1 to the fourth internal switch ISW4 in response to the first pixel switch PSW1 being turned on. Each of the first internal switch ISW1 to the fourth internal switch ISW4 may be turned on in response to the control signal CS having a logic low level.

For example, the controller 120 may electrically connect the first sub-circuit SC1a and the second sub-circuit SC2a in response to the first pixel switch PSW1 being turned on.

In addition, the controller 120 may turn off the output switches OSW1 and OSW2 in response to one of the first pixel switch PSW1 and the second pixel switch PSW2 being turned on.

For example, the controller 120 may apply a control signal CS having a logic low level to each of the first output switch OSW1 and the second output switch OSW2 in response to the first pixel switch PSW1 being turned on. Each of the first output switch OSW1 and the second output switch OSW2 may be turned off in response to the control signal CS having a logic low level.

The amplifier circuit 110A may output a second output voltage VO2 based on an input signal IN through a second output node ON2. For example, the amplifier circuit 110A may amplify the input signal IN through the first sub-circuit SC1a and the second sub-circuit SC2a and output the amplified signal as the second output voltage VO2 through the second output node ON2.

For example, the amplifier circuit 110A may operate as a multi-stage amplifier while one of the first pixel switch PSW1 and the second pixel switch PSW2 is turned on.

In addition, when the amplifier circuit 110A outputs the second output voltage VO2 through the second output node ON2, the controller 120 may turn off the first external switch OS1.

For example, the controller 120 may output a control signal CS having a logic low level in response to the first pixel switch PSW1 being turned on. The first external switch OS1 may be turned off in response to the control signal CS having a logic low level.

In addition, the controller 120 may turn on the second external switch OS2 in response to the first pixel switch PSW1 being turned on. For example, the second external switch OS2 may be turned on in response to the control signal CS having a logic low level.

Accordingly, the controller 120 may control at least a portion of the first external switch OS1 and the second external switch OS2 to transmit the second output voltage VO2 to the output node ON while the amplifier circuit 110A operates as a multi-stage amplifier.

Referring to the above-described components, the controller 120 according to one or more embodiments may control the amplifier circuit 110A based on whether the amplifier circuit 110A is electrically connected to the plurality of first pixels PX1s or the plurality of second pixels PX2s.

For example, when the amplifier circuit 110A is electrically open to the plurality of first pixels PX1s and the plurality of second pixels PX2s, the controller 120 may control the amplifier circuit 110A to operate as a single stage amplifier.

As a result, when the amplifier circuit 110A is electrically open to the plurality of first pixels PX1s and the plurality of second pixels PX2s, the controller 120 may increase a phase margin and/or a gain margin of the amplifier circuit 110A.

Accordingly, the controller 120 may reduce oscillation (or ringing) occurring at an output of the amplifier circuit 110A.

Through the above-described components, the display device 100A according to one or more embodiments may improve the quality of an image output through the display panel 102.

Referring to FIG. 6A, a controller 120 according to one or more embodiments may control a first polarity switch circuit PSC1 to connect the first PMOS transistor PT1 and the fourth PMOS transistor PT4 in response to the first pixel switch PSW1 and the second pixel switch PSW2 being turned off. In addition, the controller 120 may control the first polarity switch circuit PSC1 to connect the second PMOS transistor PT2 and the third PMOS transistor PT3 in response to the first pixel switch PSW1 and the second pixel switch PSW2 being turned off.

Referring to FIG. 7, a controller 120 according to one or more embodiments may control a first polarity switch circuit PSC1 to connect the first PMOS transistor PT1 and the third PMOS transistor PT3 in response to the first pixel switch PSW1 being turned on. In addition, the controller 120 may control the first polarity switch circuit PSC1 to connect the second PMOS transistor PT2 and the fourth PMOS transistor PT4 in response to the first pixel switch PSW1 being turned on.

Referring to FIG. 6A, the controller 120 according to one or more embodiments may control a second polarity switch circuit PSC2 to connect the first NMOS transistor NT1 and the fourth NMOS transistor NT4 in response to the first pixel switch PSW1 and the second pixel switch PSW2 being turned off. In addition, the controller 120 may control the second polarity switch circuit PSC2 to connect the second NMOS transistor NT2 and the third NMOS transistor NT3 in response to the first pixel switch PSW1 and the second pixel switch PSW2 being turned off.

Referring to FIG. 7, the controller 120 according to one or more embodiments may control a second polarity switch circuit PSC2 to connect the first NMOS transistor NT1 and the third NMOS transistor NT3 in response to the first pixel switch PSW1 being turned on. In addition, the controller 120 may control the second polarity switch circuit PSC2 to connect the second NMOS transistor NT2 and the fourth NMOS transistor NT4 in response to the first pixel switch PSW1 being turned on.

Referring to the above-described components, the controller 120 may change a connection relationship of the circuit through the polarity switch circuits PSC1 and PSC2 in response to the amplifier circuit 110A being switched to a single stage amplifier or a multi-stage amplifier.

As a result, the display control circuit 101 according to one or more embodiments may maintain the polarity (or sign) of the first output voltage VO1 and the second output voltage VO2 to be the same.

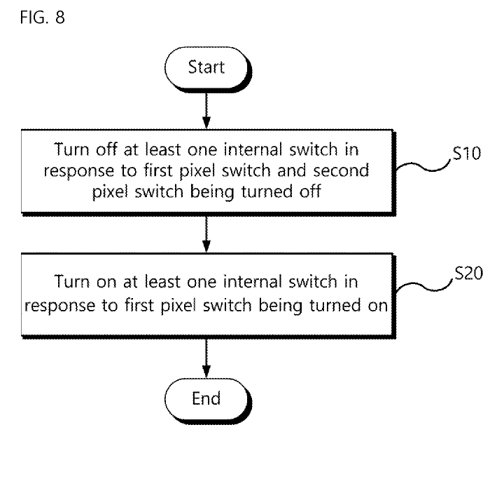

FIG. 8 is a flowchart illustrating a method of controlling an amplifier circuit according to one or more embodiments.

Referring to FIG. 8, a controller 120 (or, a display device 100) according to one or more embodiments may control an amplifier circuit 110 based on an operating state of each of a first pixel switch PSW1 and a second pixel switch PSW2. For example, the controller 120 may control the amplifier circuit 110 based on whether the amplifier circuit 110 is electrically connected to a plurality of first pixels PX1s or a plurality of second pixels PX2s.

For example, the controller 120 may control a connection relationship between a first sub-circuit SC1 and a second sub-circuit SC2 included in the amplifier circuit 110 based on an operating state of each of the first pixel switch PSW1 and the second pixel switch PSW2.

In operation S10, the controller 120 according to one or more embodiments may turn off at least one internal switch ISWs in response to a first pixel switch PSW1 and a second pixel switch PSW2 being turned off.

For example, the controller 120 may output a control signal CS having a logic high level in response to the first pixel switch PSW1 and the second pixel switch PSW2 being turned off. The at least one internal switch ISWs may be turned off in response to the control signal CS having a logic high level.

According to one or more embodiments, the amplifier circuit 110 may include a first sub-circuit SC1 and a second sub-circuit SC2 connected through the at least one internal switch ISWs.

For example, the controller 120 may open an electrical connection between the first sub-circuit SC1 and the second sub-circuit SC2 in response to the first pixel switch PSW1 and the second pixel switch PSW2 being turned off.

In addition, the controller 120 may turn on at least one output switch OSWs in response to the first pixel switch PSW1 and the second pixel switch PSW2 being turned off. The at least one output switch OSWs may be connected to a first output node ON1 from which the first sub-circuit SC1 outputs a first output voltage VO1.

The amplifier circuit 110 may output the first output voltage VO1 based on an input signal IN through the first sub-circuit SC1. For example, the amplifier circuit 110 may amplify the input signal IN using the first sub-circuit SC1 and output the amplified signal as the first output voltage VO1 through the first output node ON1.

For example, the amplifier circuit 110 may operate as a single stage amplifier while the first pixel switch PSW1 and the second pixel switch PSW2 are turned off.

In operation S20, the controller 120 according to one or more embodiments may turn on the at least one internal switch ISWs in response to the first pixel switch PSW1 being turned on.

For example, the controller 120 may output a control signal CS having a logic low level in response to the first pixel switch PSW1 being turned on. The at least one internal switch ISWs may be turned on in response to the control signal CS having a logic low level.

For example, the controller 120 may electrically connect the first sub-circuit SC1 and the second sub-circuit SC2 in response to one of the first pixel switch PSW1 and the second pixel switch PSW2 being turned on.

In addition, the controller 120 may turn off the at least one output switch OSWs in response to one of the first pixel switch PSW1 and the second pixel switch PSW2 being turned on.

The amplifier circuit 110 may output a second output voltage VO2 based on an input signal IN through the first sub-circuit SC1 and the second sub-circuit SC2. For example, the amplifier circuit 110 may amplify the input signal IN using the first sub-circuit SC1 and the second sub-circuit SC2 and output the amplified signal as the second output voltage VO2 through a second output node ON2.

For example, the amplifier circuit 110 may operate as a multi-stage amplifier while one of the first pixel switch PSW1 and the second pixel switch PSW2 is turned on.

Referring to the above-described components, the controller 120 according to one or more embodiments may control the amplifier circuit 110 based on whether the amplifier circuit 110 is electrically connected to the plurality of first pixels PX1s or the plurality of second pixels PX2s.

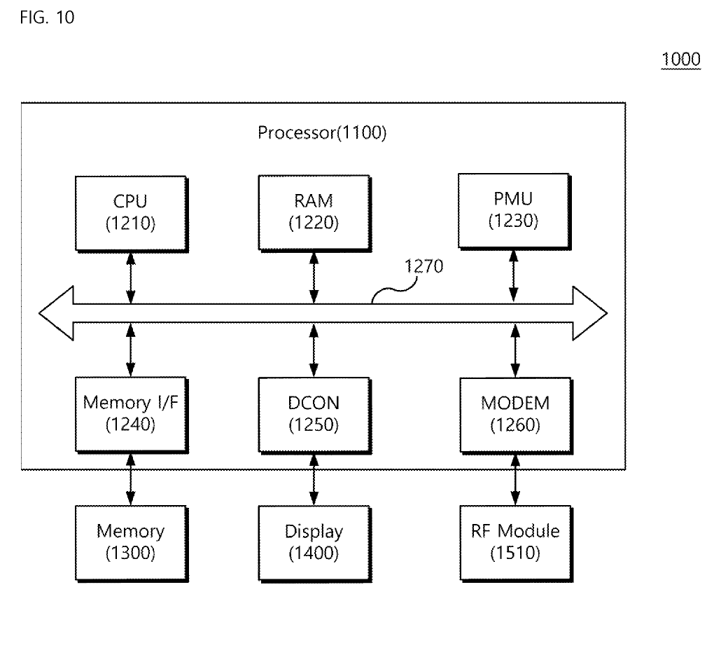

In FIG. 10, operation S20 is illustrated as being performed after operation S10 is performed, but embodiments are not limited thereto. For example, operation S10 may be performed after operation S20 is performed.

For example, when the amplifier circuit 110 is electrically open to the plurality of first pixels PX1s and the plurality of second pixels PX2s, the controller 120 may control the amplifier circuit 110 to operate as a single stage amplifier.

As a result, when the amplifier circuit 110 is electrically open to the plurality of first pixels PX1s and the plurality of second pixels PX2s, the controller 120 may increase a phase margin and/or a gain margin of the amplifier circuit 110.

Accordingly, the controller 120 may reduce oscillation (or ringing) occurring at an output of the amplifier circuit 110.

Through the above-described components, the display device 100 according to one or more embodiments may improve the quality of an image output through the display panel 102.

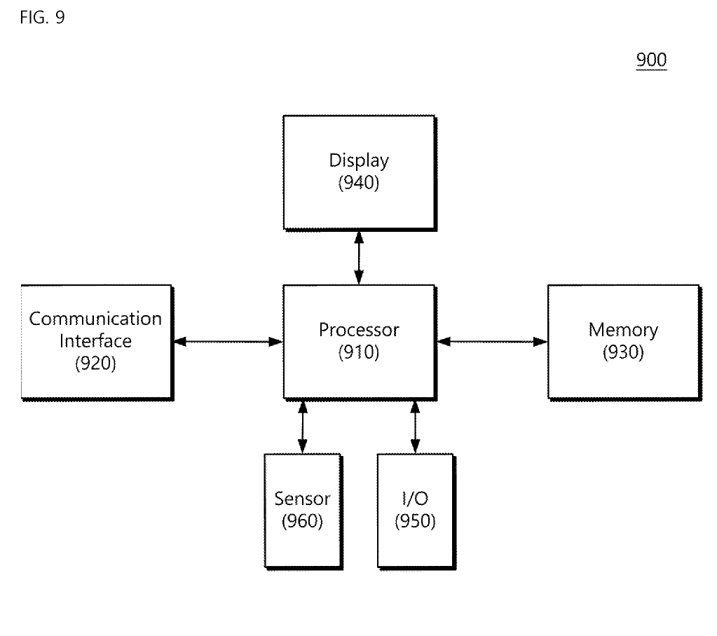

FIG. 9 is a block diagram of an Internet of Things (IoT) device including a display device according to one or more embodiments.

Referring to FIG. 9, IoT may refer to a network between things using wired and/or wireless communication. An IoT device may include an accessible wired or/and wireless interface and may include devices that communicate with at least one or more other devices through the wired or/and wireless interface to transmit or receive data. The accessible interface that the IoT device includes may include a modem communication interface that is accessible to a local area network (LAN), a wireless local area network (WLAN) such as a wireless fidelity (Wi-Fi), a wireless personal area network (WPAN) such as Bluetooth, a wireless universal serial bus (USB), Zigbee, a near field communication (NFC), a radio frequency identification (RFID), a power line communication (PLC), or mobile cellular networks such as 3rd generation (3G), long term evolution (LTE), 4th generation (4G), or 5th generation (5G).

For example, the IoT device 900 may include a communication interface 920 for communicating with an external entity. The communication interface 920 may be, for example, a wired local area network (LAN), a wireless local area communication interface such as Bluetooth, Wi-Fi, or Zigbee, a PLC, or a modem communication interface that is accessible to a mobile cellular network such as 3G, LTE, 4G, or 5G.

The communication interface 920 may include a transceiver and/or a receiver. The IoT device 900 may transmit and/or receive information from an access point or a gateway through the transceiver and/or the receiver. In addition, the IoT device 900 may communicate with a user device or another IoT device to transmit and/or receive control information or data of the IoT device 900.

The IoT device 900 may include a processor 910 that performs operations. The processor 910 illustrated in FIG. 9 may be referred to as a substantially same component as the display control circuit 101 illustrated in FIG. 1.

In addition, the IoT device 900 may include a display 940 for displaying an internal state or data. A user may control the IoT device 900 through a user interface (UI) of the display 940 of the IoT device 900.

The display 940 illustrated in FIG. 9 may be referred to as a substantially same component as the display panel 102 illustrated in FIG. 1.

Accordingly, the controller 120 (or the processor 910) may control an amplifier circuit 110 based on whether the amplifier circuit 110 is electrically connected to a plurality of first pixels PX1s or a plurality of second pixels PX2s.

For example, when the amplifier circuit 110 is electrically open to the plurality of first pixels PX1s and the plurality of second pixels PX2s, the controller 120 may control the amplifier circuit 110 to operate as a single stage amplifier.

In addition, when the amplifier circuit 110 is electrically connected to the plurality of first pixels PX1s or the plurality of second pixels PX2s, the controller 120 may control the amplifier circuit 110 to operate as a multi-stage amplifier.

As a result, the controller 120 may increase a phase margin and/or a gain margin of the amplifier circuit 110 while the amplifier circuit 110 is electrically open to the plurality of first pixels PX1s and the plurality of second pixels PX2s.

Accordingly, the controller 120 may reduce oscillation (or ringing) occurring at an output of the amplifier circuit 110.

Through the above-described components, the IoT device 900 according to one or more embodiments may improve the quality of an image output through the display 940.

The IoT device 900 may have a built-in battery to supply internal power or may further include a power supply receiving power from an external entity.

A memory 930 may store a control command code, control data, or user data for controlling the IoT device 900. The memory 930 may include at least one of a volatile memory or a non-volatile memory. The non-volatile memory may include at least one of various memories such as a read only memory (ROM), a programmable ROM (PROM), an electrically programmable ROM (EPROM), an electrically erasable and programmable ROM (EEPROM), a flash memory, a phase-change random access memory (RAM) (PRAM), a magnetic RAM (MRAM), a resistive RAM (ReAM), or a ferroelectric RAM (FRAM). The volatile memory may include at least one of various memories such as a dynamic RAM (DRAM), a static RAM (SRAM), or a synchronous DRAM (SDRAM).

The IoT device 900 may further include a storage device. The storage device may include at least one of non-volatile media such as a hard disk drive (HDD), a solid state drive (SDD), an embedded multi-media card (eMMC), or a universal flash storage (UFS). The storage device may store user information provided through an input/output (I/O) unit 950 and sensing information collected through a sensor 960.

FIG. 10 is a block diagram of a mobile terminal to which a display device according to one or more embodiments is applied.

Referring to FIG. 10, a mobile terminal 1000 may include a processor 1100, a memory 1300, a display 1400, and a radio-frequency (RF) module 1510. The mobile terminal 1000 may further include various components such as a lens, a sensor, or an audio module.

The processor 1100 may be implemented as a system on chip (SoC), and may include a central processing unit (CPU) 1210, a RAM 1220, a power management unit (PMU) 1230, a memory interface (memory I/F) 1240, a display controller (DCON) 1250, a modem 1260, and a bus 1270. The processor 1100 may further include various intellectual properties (IPs). The processor 1100 may be referred to as a “ModAP” as the function of a modem chip may be integrated therein, but embodiments are not limited thereto.

The CPU 1210 may control the overall operation of the processor 1100 and the mobile terminal 1000. The CPU 1210 may control the operation of each component of the processor 1100. In addition, the CPU 1210 may be implemented as a multi-core processor. A multi-core processor is a single computing component having two or more independent cores.

The RAM 1220 may temporarily store programs, data, or instructions. For example, programs and/or data stored in the memory 1300 may be temporarily stored in the RAM 1220 under the control of the CPU 1210 or based on a booting code. The RAM 1220 may be implemented as a DRAM or an SRAM.

The PMU 1230 may manage power of each component of the processor 1100. The PMU 1230 may determine an operating status of each component of the processor 1100 and control the operation.

The memory interface 1240 may control the overall operation of the memory 1300 and may control data exchange between each component of the processor 1100 and the memory 1300. The memory interface 1240 may write data to the memory 1300 or read data from the memory 1300 based on a request of the CPU 1210.

A display controller 1250 may transmit video data to be displayed on the display 1400 to the display 1400. The display controller 1250 illustrated in FIG. 10 may be understood as a substantially same component as the display control circuit 101 illustrated in FIG. 1.

The display 1400 may be implemented as a flat panel display such as a liquid crystal display (LCD) or an organic light emitting diode (OLED), or a flexible display. The display 1400 illustrated in FIG. 10 may be understood as a substantially same component as the display panel 102 illustrated in FIG. 1.

Accordingly, the display controller 1250 may control an amplifier circuit 110 based on whether the amplifier circuit 110 is electrically connected to a plurality of first pixels PX1s or a plurality of second pixels PX2s.

For example, when the amplifier circuit 110 is electrically open to the plurality of first pixels PX1s and the plurality of second pixels PX2s, the display controller 1250 may control the amplifier circuit 110 to operate as a single stage amplifier.

In addition, when the amplifier circuit 110 is electrically connected to the plurality of first pixels PX1s or the plurality of second pixels PX2s, the display controller 1250 may control the amplifier circuit 110 to operate as a multi-stage amplifier.

As a result, the display controller 1250 may increase a phase margin and/or a gain margin of the amplifier circuit 110 while the amplifier circuit 110 is electrically open to the plurality of first pixels PX1s and the plurality of second pixels PX2s.

Accordingly, the display controller 1250 may reduce oscillation (or ringing) of an output of the amplifier circuit 110.

Through the above-described components, the mobile terminal 1000 according to one or more embodiments may improve the quality of an image output through the display 1400.

The modem 1260 may modulate data to be transmitted to be appropriate to a wireless environment for wireless communication and may recover received data. The modem 1260 may perform digital communication with the RF module 1510.

The RF module 1510 may convert a high-frequency signal, received through an antenna, into a low-frequency signal and may transmit the converted low-frequency signal to the modem 1260. In addition, the RF module 1510 may convert a low-frequency signal, received from the modem 1260, into a high-frequency signal and may transmit the converted high-frequency signal to the outside of the mobile terminal 1000 through the antenna. The RF module 1510 may amplify or filter a signal.

As described above, a controller 120 according to one or more embodiments may control an amplifier circuit 110 based on whether the amplifier circuit 110 is electrically connected to a plurality of first pixels PX1s or a plurality of second pixels PX2s.

For example, when the amplifier circuit 110 is electrically open to the plurality of first pixels PX1s and the plurality of second pixels PX2s, the controller 120 may control the amplifier circuit 110 to operate as a single stage amplifier.

In addition, when the amplifier circuit 110 is electrically connected to the plurality of first pixels PX1s or the plurality of second pixels PX2s, the controller 120 may control the amplifier circuit 110 to operate as a multi-stage amplifier.

As a result, the controller 120 may increase a phase margin and/or a gain margin of the amplifier circuit 110 while the amplifier circuit 110 is electrically open to the plurality of first pixels PX1s and the plurality of second pixels PX2s.

Accordingly, the controller 120 may reduce oscillation (or ringing) occurring at an output of the amplifier circuit 110.

Through the above-described components, the display device 100 according to one or more embodiments may improve the quality of an image output through the display panel 102.

As set forth above, according to embodiments, a display device may improve the quality of an image output through a display panel.

While various embodiments have been shown and described above, it will be apparent to those skilled in the art that modifications and variations could be made without departing from the scope of the present inventive concept as defined by the appended claims.

What is claimed is:

1. A display control circuit comprising:
an amplifier circuit connected to a plurality of first pixels through a first pixel switch and to a plurality of second pixels through a second pixel switch; and
a controller electrically connected to the amplifier circuit,
wherein:
the amplifier circuit comprises a first sub-circuit and a second sub-circuit connected to each other through at least one internal switch; and
the controller is configured to turn off the at least one internal switch in response to each of the first pixel switch and the second pixel switch being turned off, such that the amplifier circuit outputs a first output voltage based on an input signal through the first sub-circuit.

2. The display control circuit of claim 1, wherein:
the controller is further configured to turn on the at least one internal switch in response to the first pixel switch being turned on, such that the amplifier circuit outputs a second output voltage based on the input signal through the first sub-circuit and the second sub-circuit.

3. The display control circuit of claim 2, wherein:
the amplifier circuit further comprises a first output switch and a second output switch, each connected to a first output node from which the first output voltage is output; and
the controller is further configured to turn on the first output switch and the second output switch in response to each of the first pixel switch and the second pixel switch being turned off.

4. The display control circuit of claim 3, wherein:
the first sub-circuit comprises:
a first PMOS transistor and a second PMOS transistor, each connected to a power supply voltage
a first polarity switch circuit connected to drain electrodes of the first PMOS transistor and the second PMOS transistor; and
a third PMOS transistor and a fourth PMOS transistor, each connected to the first polarity switch circuit,
wherein each of the first PMOS transistor, the second PMOS transistor, the third PMOS transistor, and the fourth PMOS transistor includes a gate electrode,
wherein the gate electrode of the first PMOS transistor is connected to the gate electrode of the second PMOS transistor, and
wherein the gate electrode of the third PMOS transistor is connected to the gate electrode of the fourth PMOS transistor.

5. The display control circuit of claim 4, wherein:
the controller is further configured to:
connect the first PMOS transistor and the fourth PMOS transistor and connect the second PMOS transistor and the third PMOS transistor through the first polarity switch circuit in response to each of the first pixel switch and the second pixel switch being turned off; and
connect the first PMOS transistor to the third PMOS transistor and connect the second PMOS transistor to the fourth PMOS transistor in response to each of the first pixel switch being turned on.

6. The display control circuit of claim 4, wherein:
the first sub-circuit further comprises:
a first NMOS transistor and a second NMOS transistor, each connected to a ground;
a second polarity switch circuit connected to drain electrodes of the first NMOS transistor and the second NMOS transistor; and
a third NMOS transistor and a fourth NMOS transistor, each connected to the second polarity switch circuit,
wherein each of the first NMOS transistor, the second NMOS transistor, the third NMOS transistor, and the fourth NMOS transistor includes a gate electrode,
wherein the gate electrode of the first NMOS transistor is connected to the gate electrode of the second NMOS transistor, and
wherein the gate electrode of the third NMOS transistor is connected to the gate electrode of the fourth NMOS transistor.

7. The display control circuit of claim 6, wherein:
the first sub-circuit further comprises:
a first internal switch connected, in parallel with the first output switch, to the fourth PMOS transistor; and
a second internal switch connected, in parallel with the second output switch, to the fourth NMOS transistor.

8. The display control circuit of claim 4, wherein:
the second sub-circuit comprises:
an output PMOS transistor and an output NMOS transistor connected in series between the power supply voltage and a ground; and
a first capacitor and a second capacitor, each connected to a second output node from which the second output voltage is output, the second output node disposed between the output PMOS transistor and the output NMOS transistor.

9. The display control circuit of claim 8, further comprising:
a first external switch connected to the first output node; and
a second external switch connected to the second output node,
wherein:
the controller is further configured to turn on the first external switch and turn off the second external switch in response to each of the first pixel switch and the second pixel switch being turned off.

10. The display control circuit of claim 1, wherein:
the amplifier circuit is configured to receive the input signal through a first input node; and
a second input node of the amplifier circuit is connected to an output node of the amplifier circuit.

11. A display device comprising:
an amplifier circuit comprising a first sub-circuit and a second sub-circuit connected to each other through at least one internal switch;
a plurality of first pixels connected to the amplifier circuit through a first pixel switch;
a plurality of second pixels connected to the amplifier circuit through a second pixel switch; and
a controller electrically connected to the amplifier circuit,
wherein:
the controller is configured to:
turn off the at least one internal switch in response to each of the first pixel switch and the second pixel switch being turned off; and
turn on the at least one internal switch in response to the first pixel switch being turned on.

12. The display device of claim 11, wherein:
the amplifier circuit further comprises a first output switch and a second output switch each connected to a first output node from which a first output voltage is output; and
the controller is further configured to:
turn on the first output switch and the second output switch in response to each of the first pixel switch and the second pixel switch being turned off; and
turn off the first output switch and the second output switch in response to the first pixel switch being turned on.

13. The display device of claim 12, wherein:
the first sub-circuit comprises:
a first PMOS transistor and a second PMOS transistor, each connected to a power supply voltage and each having a gate electrode, wherein the gate electrode of the first PMOS transistor and the gate electrode of the second PMOS transistor are connected to each other;
a first polarity switch circuit connected to drain electrodes of the first PMOS transistor and the second PMOS transistor;
a third PMOS transistor connected to the first polarity switch circuit and having a drain electrode connected to each of the gate electrode of the first PMOS transistor and the gate electrode of the second PMOS transistor; and
a fourth PMOS transistor connected between the first polarity switch circuit and the first output switch and having a gate electrode of the fourth PMOS transistor connected to a gate electrode of the third PMOS transistor.

14. The display device of claim 13, wherein:
the controller is further configured to:
connect the first PMOS transistor and the fourth PMOS transistor and connect the second PMOS transistor and the third PMOS transistor through the first polarity switch circuit in response to each of the first pixel switch and the second pixel switch being turned off, and
connect the first PMOS transistor and the third PMOS transistor and connect the second PMOS transistor and the fourth PMOS transistor in response to the first pixel switch being turned on.

15. The display device of claim 13, wherein:
the second sub-circuit comprises:
an output PMOS transistor connected between a second output node from which a second output voltage is output, and the power supply voltage;
an output NMOS transistor connected between the second output node and a ground; and
a first capacitor and a second capacitor connected in series and each connected to the second output node.

16. The display device of claim 15, further comprising:
a first external switch connected to the first output node; and
a second external switch connected to the second output node,
wherein:
the controller is further configured to turn on the first external switch and turn off the second external switch in response to each of the first pixel switch and the second pixel switch being turned off.

17. The display device of claim 13, wherein:
the first sub-circuit further comprises:
a first NMOS transistor and a second NMOS transistor, each connected to a ground and each having a gate electrode, wherein the gate electrode of the first NMOS transistor and the gate electrode of the second NMOS transistor are connected to each other;
a second polarity switch circuit connected to drain electrodes of the first NMOS transistor and the second NMOS transistor;
a third NMOS transistor connected to the second polarity switch circuit, and having a drain electrode connected to each of the gate electrode of the first NMOS transistor and the gate electrode of the second NMOS transistor; and
a fourth NMOS transistor connected between the second polarity switch circuit and the second output switch and having a gate electrode of the fourth NMOS transistor connected to a gate electrode of the third NMOS transistor.

18. The display device of claim 11, wherein:
the first pixel switch is configured to be turned on after a first time interval from a time point at which the second pixel switch is turned off.

19. The display device of claim 11, wherein:
the amplifier circuit is configured to receive an input signal through a first input node; and
a second input node of the amplifier circuit is connected to an output node of the amplifier circuit.

20. A method of controlling an amplifier circuit connected to first pixels through a first pixel switch and to second pixels through a second pixel switch, the method comprising:
turning off at least one internal switch connected between a first sub-circuit and a second sub-circuit in response to the first pixel switch and the second pixel switch being turned off, such that the amplifier circuit outputs a first output voltage based on an input signal through the first sub-circuit; and
turning on the at least one internal switch in response to the first pixel switch being turned on, such that the amplifier circuit outputs a second output voltage based on the input signal through the first sub-circuit and the second sub-circuit.
